(19) United States
(12) Patent Application Publication
(10) Pub. No.: US 2001/0031334 A1
(43) Pub. Date: Oct. 18, 2001

(54) Composite sintered bodies and a process for producing the same

(75) Inventors: Yuji Katsuda, Tsushima City (JP); Masaaki Masuda, Nagoya City (JP); Yayo Akai, Nagoya City (JP); Tomio Suzuki, Yokkaichi City (JP)

Correspondence Address: Stephen P. Burr, BURR & BROWN, P.O. Box 7068, Syracuse, NY, 13261-7068, US

(73) Assignee: NGK Insulators, Ltd.

(21) Appl. No.: 09/741,139

(22) Filed: Dec. 19, 2000

(30) Foreign Application Priority Data
Dec. 28, 1999 (JP) 11-374,176

(51) Int. Cl. B32B 3/02

(52) U.S. Cl. 428/65.3

(57) ABSTRACT

A composite sintered body produced from a glass powder and a powder of a conductive oxide, said sintered body having a glass phase and a conductive oxide phase dispersed in the glass phase, wherein the conductive oxide phase extends continuously three-dimensionally, and the composite sintered body has a volume resistance value of not more than 100 MΩ·cm.

### BACKGROUND OF THE INVENTION

(1) Field of the Invention

The present invention relates to composite sintered bodies having conductivity, a process for producing the same and parts for electronic devices made of such composite sintered bodies.

(2) Related Art Statement

The recording density of the hard disc drives has been recently rapidly increasing. In order to increase the recording density, it is necessary to reduce track width of signals recorded in the magnetically recording medium or reduce the bit length. This means that the magnetic field recorded in the medium surface becomes very weak. The increased recording density is based on improvement of the magnetic head technology represented by the magnetic resistive effect type head and the giant magnetic resistive effect type head which have high sensitivity to enable read-out with weak signals. There is also an improvement on media represented by a technique of forming magnetic films having such a high magnetic performance to maintain large magnetic fields despite of reduced track width and bid length. Further, it is an indispensable technique to reduce a distance between the magnetic head and the medium (head-floating amount) at a time of the hard disc drive mode for reading out writing weak signals. For example, hard discs which have a specification with a head-floating amount of 50 nm and the maximum height of projections at the medium surface of 25 nm have recently begun to be used.

In order to cope with the reduced head-floating amount, various kinds of glass substrates have been proposed. However, since the glass substrate generally has no conductivity, static electricity is likely to stay at the surface of the substrate. Therefore, it may be that dust attaches to the surface of the substrate surface on producing the magnetic disc, thereby reducing the yield of the media.

Further, bias voltage can be applied to the aluminum substrate when a magnetic film is to be formed thereon by sputtering. However, bias voltage cannot be applied to the glass substrate at that time. Since the magnetic performance of the resulting magnetic film is more excellent in the application of the bias voltage than in the application of no bias voltage, conductive glass substrates have been demanded.

When a magnetic resistance element or a giant magnetic resistance element is used, staying of static electricity at the medium surface causes the electrostatic fracture of the element. Therefore, the medium surface needs to be earthed. The medium surface is earthed via a spacer or a clamp hub member. Therefore, materials for the spacer and the clamp hum member are required to be conductive. The specific resistance values thereof are not more than 100 MΩ·cm. Therefore, non-conductive ceramics such as alumina have not been used except for special uses.

Under these circumstances, conductive glass and ceramics have been sought, but no appropriate materials are found. For this reason, conductive glass-substituting materials are now being sought.

### SUMMARY OF THE INVENTION

It is an object of the present invention to provide a glass-substituting material which has sufficient conductivity as an earthening part for an electronic device, for example.

The present invention relates to a composite sintered body produced from a glass powder and a powder of a conductive oxide, said sintered body having a glass phase and a conductive oxide phase dispersed in said glass phase, wherein said conductive oxide phase extends continuously three-dimensionally, and the composite sintered body has a volume resistance value of not more than 100 MΩ·cm.

The present invention also relates to a conductive part for an electronic device, which conductive part comprises the above composite sintered body.

The present inventors succeeded in producing the composite sintered body, by the steps of preparing a molded body by molding a mixed powder of a glass powder and a powder of a conductive oxide, sintering the glass powder by heating the molded body, and thereby forming a glass phase and a conductive oxide phase dispersed in said glass phase. In the microstructure of the composite sintered body, the entire skeleton of the composite sintered body is formed though sintering the glass powder, and the continuous phase is formed in which the conductive oxide powdery particles contact with one another. As a result, it is found that the composite sintered body has both tempered glass-like properties and relatively high conductivity.

These and other objects, features and advantages of the invention will be appreciated upon reading of the following description of the invention with the understanding that some modifications, variations and changes could be easily made by the skilled person in the art to which the invention pertains.

In the composite sintered body, the conductive oxide phase needs to continuously connect and extend three-dimensionally, which exhibits conductivity. On the other hand, the glass phase is principally an insulating body, needs not bear conductivity, and function an adhesive for the conductive oxide phase.

The electric resistivity of the composite sintered body according to the present invention is not more than 100 MΩ·cm, and particularly preferably not more than 10 MΩ·cm. Although no lower limit is posed, the electric resistivity of the composite sintered body is higher than that of the conductive oxide itself, and is ordinarily not less than 10 Ω·cm.

When the glass powder is to be sintered, the molded body is heated up to near the softening point of the glass. The heating temperature is preferably not less than (Tg—150)° C. and more preferably not less than (Tg—100)° C. in which Tg is a softening point of the glass. Although no upper limit is posed upon the heating temperature, the upper limit of the heating temperature is preferably Tg, more preferably (Tg—10)° C. in case that the glass is not crystallized. In this case, the glass is prevented from being foamed. On the other hand, if a part of the glass is crystallized, the upper limit of the heating temperature may exceed Tg.

As one embodiment of the present invention, at least a part of the glass phase is crystallized. By so doing, the Young's modulus of the composite sintered body is further enhanced.

In order to exhibit conductivity, the content of the conductive oxide phase in the composite sintered body is not less than 10%. Particularly, the conductive oxide phase is preferably contained at not less than 20 wt % of the composite sintered body. In this case, the conductivity of the composite sintered body can be further increased. In general, as the ratio of the conductive oxide phase decreases, the particles of the conductive oxide do not contact or connect to one another, so that desired conductivity is unlikely to be attained. From this point of view, the conductive oxide phase is more preferably contained at not less than 25 wt % of the composite sintered body.

Further, as the ratio of the glass phase decreases, physical properties such as Young's modulus and strength tend to be degraded. Therefore, the view, the conductive oxide phase is preferably contained at not more than 70 wt % of the composite sintered body.

Although the composite sintered body according to the present invention is not any particular use, it is suitable for an electronic device, particularly as earthening part. The composite sintered body is also suitable particularly for magnetically recording device, for example, as a magnetic disc substrate, a spacer, a clamp hub, etc. For, the composite sintered body generally has high strength, Young's modulus and conductivity.

Further, the composite sintered body preferably has an open porosity of not than 0.5%. In this case, the composite sintered body can be favorably applied to uses disliking occurrence of particles, for example, electric devices.

Furthermore, the coefficient of thermal expansion of the composite sintered body can be adjusted by selecting a material for each of the glass phase and the conductive oxide phase. Particularly, the composite sintered body in which the coefficient of thermal expansion is adjusted to not less than 6 ppm/K and not more than 10 ppm/K is suitable particularly for magnetically recording device, for example, as a magnetic disc substrate, a spacer, a clamp hub, etc. The composite sintered body in which the coefficient of thermal expansion is adjusted to not less than 3 ppm/K and not more than 5 ppm/K is suitable particularly for semiconductor-producing apparatuses and as electric parts for semiconductors.

The composite sintered body preferably has a Young's modulus of not less than 100 Gap.

Although no particular limitation is posed for selecting the conductive oxides, an oxide of Sn, Ti, Zn, Fe, In, Cr, Nb, V, Mo, Mn, Ni, Co or Cu is used as a main phase.

Among them, at least one metal oxide selected from the group consisting of SnO₂, ZnO, Fe₂O₃, In₂O₃, CrO₂, V₂O₃, Fe₃O₄, MnO₂, Mn₃O₄, CoO, Co₃O₄, ZnFe₂O₄,NiO and BaTiO₃ are preferred, and at least one metal oxide selected from the group consisting of SnO₂, In₂O₃, Fe₃O₄, MnO₂, ZnFe₂O₄ and BaTiO₃ are more preferable.

In this case, said conductive oxide phase contains an oxide of other metal element that has a valency greater than that of metal element constituting the metal oxide and is solid solved in the metal oxide may be incorporated and solid solved in the conductive oxide phase. By solid solving two or more kinds of the metal oxides having different valencies, the conductivity of the conductive oxide phase can be further enhanced. That is, the conductivity of an oxide of a metal exhibiting a n-type semiconductor performance is generally increased by incorporating and solid solving an oxide of a metal having a valency greater than that of the former metal thereinto.

For example, as to an oxide of a tetravalent metal, such as SnO₂, it is preferable that an oxide of a pentavalent metal oxide is added or an oxide of a metal to be solid solved in a pentavalent state is added. Such other metal oxides, at least one metal oxide selected from the group consisting of Sb₂O₃, Sb₂O₅, Ta₂O₅ and Nb₂O₅ is preferred.

As a preferred embodiment of the present invention, the conductive oxide phase has a main phase composed of at least one metal oxide selected from the group consisting of NiO and CoO. In this case, atomic controlling is effected by incorporating an oxide of other metal element being capable of solid solving into said at least one metal oxide and having a valency smaller than that of the metal elements constituting the above metal oxides into said at least one metal oxide. Generally, as to the metal oxide exhibiting the p-type semiconductor performance, it is effective to add and solid-solve an oxide of a metal having a valency smaller than that of the metal in the metal oxide so as to increase the conductivity. As such another metal oxide, LiO₂ may be recited.

The amount of said oxide of said other metal element is not limited, so long as it is less than 100 parts by weight when the amount of metal oxide constituting the main phase is taken as 100 parts by weight. However, it is generally preferable not more than 30 wt %, and particularly preferably not more than 20 parts by weight. Further, not less than 0.1 parts by weight is preferable from the standpoint of reducing the resistance of the conductive oxide phase through controlling the valency.

In the above embodiment, it is preferable that the main phase of the conductive oxide phase is SnO₂, and said oxide of said other metal element is at least one metal oxide selected from the group consisting of Sb₂O₃, Sb₂O₅, Ta₂O₅ and Nb₂O₅.

When the present invention is to be applied particularly to a hard disc part, it is necessary to suppress the alkali metal from oozing out to the surface of the part under high temperature and high humid condition. From this point of view, an amount of an oxide of an alkali metal element in said glass phase is preferably not more than 15 wt %, and more preferably not more than 10 wt %.

Since Li has a particularly high oozing-out degree, an amount of lithium oxide in said glass phase is not more than 1 wt %.

It is preferable that a total dissolved amount per a unit surface area of said composite sintered body of an alkali metal element into 50 ml pure water when the composite sintered body is immersed in the pure water at 80° C. for 24 hours is not more than 5.0 μm.

The number of particles of not less than 2 μm generated per a unit surface area of the composite sintered body in a ultrasonic wave-applying test in pure water is not more than 100/cm².

As to a part for an electronic device, for example, a spacer, a center-line average surface roughness is preferably not more than 0.5 μm. Since the composite sintered body according to the present invention has a low porosity, it can be easily finely polished. Thus, the center-line average surface roughness can be reduced to not more than 0.5 μm, and worked dust is unlikely to be attached to the part on polishing.

No limitation is posed upon glass to be used in the present invention. Generally, glass containing at least alumina and silica is preferred. Particularly, SiO₂—Al₂O₃-alkali metal oxide based glass, SiO₂—Al₂O₃-alkaline earth metal oxide based glass, and SiO₂—Al₂O₃—B₂O₃ based glass are preferred.

Silica (SiO₂) is a skeleton component forming glass. In order to increase the viscosity on forming the glass and the strength of the composite sintered body is increased and impart chemical durability, the amount of silica is preferably not less than 30 wt %. On the other hand, the melting temperature of the glass can be reduced by setting the amount of silica to not more than 70 wt %.

In order to stabilize glass, prevent devitrification on molding and imparting strength upon the product, alumina (Al₂O₃) is preferably in an amount of not less than 1 wt %. On the other hand, glass can be easily melted by setting the amount of alumina to not more than 20 wt %.

Li₂O has an effect to reduce the viscosity of glass. The amount of Li₂O is preferably not more than 1 wt % from the point of view of preventing the alkali from oozing out as mentioned above, and it is more preferably substantially not contained.

In the case of the crystallized glass, at least one kind of nucleus-forming components selected from titanium oxide, zirconium oxide and phosphorous oxide may be incorporated. When such nucleus-forming component(s) is added, it is preferably in an amount of 2 wt % of the raw glass. By so doing, a number offline crystal particles are uniformly produced, and production of coarse crystals is suppressed. Among the above three nucleus-forming components, titanium oxide is most effective in producing fine crystalline particles.

Further, at least one alkaline earth metal oxide selected from the group consisting of magnesium oxide, barium oxide and calcium oxide may be incorporated into glass.

The addition of magnesium oxide increases strength and chemical durability of glass. Devitrification on molding can be prevented by setting the amount of magnesium oxide to not more than 22 wt %.

Barium oxide has an effect to increase the coefficient of thermal expansion of the glass and prevent devitrification on molding. Glass can be more easily molded by setting the amount of barium oxide to not more than 40 wt %.

Calcium oxide increases strength of glass before heat treatment, raises the coefficient of thermal expansion and prevents devitrification. Considerable reduction in viscosity of the glass can be prevented by setting the amount of calcium oxide to not more than 50 wt %.

Since potassium oxide has an effect to increase the coefficient of thermal expansion of glass. From this point of view, potassium oxide is favorable for magnetic disc drive parts, particularly for magnetic disc substrates, and may be added in an amount of not less than 5 wt %. Further, the amount of potassium oxide is preferably not more than 3 wt % for the above reasons.

Since sodium oxide has almost the same effect as potassium oxide, the former may be added into the glass in the present invention. In this case, the total amount of potassium oxide and sodium oxide is preferably not more than 10 wt % for the above reasons. Further, sodium oxide is more preferably substantially not contained.

From the above point of view, substantially none of sodium and potassium is preferably contained in glass. In this case, that substantially none of sodium and potassium is preferably contained in glass means that inevitable inclusion of Na and K as impurities in other oxide raw materials is permissible.

In the glass of the present invention, 0 to 3 wt % of ZnO may be incorporated. ZnO reduces the melting temperature of the raw glass. If ZnO exceeds 3 wt %, the glass is likely to be devitrified. More preferably, ZnO is not more than 1.5 wt %.

Sb₂O₃ may be incorporated in an amount of 0 to 2 wt %. Sb₂O₃ defoams glass. Sb₂O₃ is saturated in an amount of 2 wt %. More preferably, Sb₂O₃ is not less than 1 wt % and not more than 1 wt %.

Nb₂O₃ may be incorporated in an amount of 0 to 6 wt %. Addition of Nb₂O₅ decreases variations in coefficient of thermal expansion when the crystallizing temperature moves. If Nb₂O₃ is more than 6 wt %, crystalline particles become coarse. More preferably, Nb₂O₃ is not more than 2 wt %.

As₂O₃ may be incorporated in an amount of 0 to 2 wt %. This is a clarifying agent on melting glass. Further, B₂O₃ may be incorporated in an amount of 0 to 3 wt %.

A transition metal may be incorporated into the glass phase in such a fine amount as to color the composite sintered body in desired tint and tone. This is because the transition metal incorporated is dissolved in the glass as metal ions, and electrons of the metal ions transfer through absorption of light. As such transition metals, cobalt, chromium, manganese, titanium, vanadium, iron, nickel, copper and molybdenum are preferred.

According to the above, even extremely similar composite sintered bodies can be easily discriminated from each other or one another by changing the tints and tones through varying the kinds of the transition metals in a fine amount. Particularly, when the present invention is applied to electronic device parts, it takes a time for discriminating the parts because they are small. In that case, different kinds of electronic device parts may be easily discriminated by respectively changing the tints.

### EXAMPLES

### Examples 1 to 13

Composite sintered bodies in Examples 1 to 13 were produced, and their physical properties are shown in Tables 1 to 4.

### Example 1

Carbonates, nitrates, oxides, etc. of various components were selectively measured and mixed to formulate a mixture having composition of SiO₂: 76.1 wt %, Li₂O: 9.9 wt %, Al₂O₃: 5.1 w %, K₂O: 2.8 wt %, ZrO₂: 4.0 wt %, P₂O₅: 1.9 wt % and Sb₂O₃: 0.2 wt %. The formulated composition was placed in a crucible, and roughly melted at 1300° C., and the melted glass was fed into flowing water from the crucible, thereby obtaining coarse cullet particles. The cullet was put into the crucible again, and the glass was uniformly melted by heating it at 1400° C. under stirring. Then, the glass was crushed into pieces, thereby obtaining a powder having the average particle diameter of 6.5 μm. The softening temperature of the glass was measured to be 920° C. with use of a heating micrometer.

SnO₂ powder (100 parts by weight) and Sb₂O₃ powder (5 parts by weight) having the average particle diameter of not more than 1 μm were mixed together (The ratio of Sb₂O₃ powder is 4.7 wt %). The mixed powder was heated at 1000° C. for 4 hours, thereby obtaining SnO₂ powder in which Sb was solid solved.

The above glass powder and the conductive oxide powder were measured to give a weight ratio of 65:35. These powders were wet mixed in a pot mill for 5 hours with use of isopropyl alcohol as a solvent and zirconia particles having a diameter of 5 mm as mixing balls. After mixing, the slurry was taken out, and the solvent was evaporated in a dryer, and the dried material was sieved, thereby obtaining the mixed powder.

A molded body was prepared by molding the mixed powder with a uniaxial press drier. The press pressure was 20 MPa. The molded body had a discoid shape and dimensions of 30 mm in diameter and 8 mm in thickness. Then, the molded body was heated at 900° C. in air for 2 hours, thereby obtaining a sintered body. The heating rate was 300° C./h, and the cooling rate between 900° C. and 500° C. was 300° C./h. The following evaluations were made with respect to the thus obtained sintered body.

(Density and Open Porosity)

The density and the open porosity of the sintered body were measured by the Archimedean method. Water was used as a medium.

(Electric Resistivity)

A test piece having dimensions of 4 mm×3 mm×20 mm was prepared from the composite sintered body, and its electric resistivity was measured at room temperature according to the four-terminal method.

(Coefficient of Thermal Expansion)

A test piece having dimensions of 4 mm×3 mm×20 mm was prepared from the composite sintered body, and its coefficient of thermal expansion between 40 and 300° C. were measured with a press rod type thermal expansion meter.

(Young's Modulus and Strength)

A test piece having dimensions of 2 mm×1.5 mm×20 mm was prepared from the composite sintered body, and stretch faces were polished and C-chamfered with a #800 grinding stone. The Young's modulus and strength were measured by using a four-point bending tester.

(Alkali Oozing-Out Amount)

A test piece having dimensions of 4 mm×3 mm×20 mm was placed in a Teflon container with 50 ml pure water, and the container was sealed and held at 80° C. for 24 hours. Amounts of lithium, sodium and potassium dissolved into the pure water were measured by atomic-absorption spectroscopy, and the dissolved amounts per unit surface area of the composite sintered body were calculated.

(Tone)

Tone was visually observed.

(Crystalline Phase)

The composite sintered body was ground, and the crystalline phase was identified according to the powder X-ray diffraction method.

### Example 2

A composite sintered body was produced in the same manner as in Example 1 except that the sintering temperature was 900° C. and the holding time at 900° C. was 10 hours. As compared with the sintered body in Example 1, the sintered body in Example 2 had more crystalline phases (not identified) precipitated in the glass phase, and the coefficient of thermal expansion of the sintered body was smaller. Therefore, it is considered in the composite sintered body of Example 2 that the non-identified crystalline phases have low coefficients of thermal expansion.

### Example 3

A composite sintered body was produced in the same manner as in Example 1 except that the following glass was used, the sintering temperature was 700° C., and the holding time at 700° C. was 4 hours.

The glass had a composition of a mixture having composition of SiO₂: 72.4 wt %, Al₂O₃: 2.0 w %, CaO: 8.0 wt %, MgO : 3.2 wt %, Na₂O: 14.0 wt %, and K₂O: 0.4 wt %. The sintered body was ground. The glass powder had the average particle diameter of 6.5 μm. The softening temperature of the glass was measured to be 800° C. with use of the heating micrometer.

### Example 4

A composite sintered body was produced in the same manner as in Example 3 except that the mixing ratio and condition of the glass powder and the conductive oxide powder were changed as follows.

The glass powder and the conductive oxide powder were measured to give the ratio of 70 parts by weight: 30 parts by weight. These powders were wet mixed in a pot mill for 5 hours with use of isopropyl alcohol as a solvent and zirconia particles having a diameter of 5 mm as mixing balls.

### Example 5

A composite sintered body was produced in the same manner as in Example 1 except that the following glass was used, the sintering temperature was 925° C., and the holding time at 925° C. was 2 hours.

The glass had a composition of a mixture having composition of SiO₂: 60.0 wt %, Al₂O₃: 14.4 w %, CaO: 23.9 wt %, MgO: 0.2 wt %, and Na₂O: 1.5 wt %. The glass powder had the average particle diameter of 6.8 μm. The softening temperature of the glass was measured to be 970° C. with use of the heating micrometer.

### Example 6

A composite sintered body was produced in the same manner as in Example 1 except that the following glass was used, the sintering temperature was 865° C., and the holding time at 865° C. was 2 hours. The weight mixing ratio of a glass powder and a conductive oxide powder was 70:30.

The glass had a composition of a mixture having composition of SiO₂: 49.0 wt %, Al₂O₃: 14.0 w %, CaO: 35.0 wt %, MgO: 0.5 wt %, and Na₂O: 1.5 wt %. The glass powder had the average particle diameter of 6.5 μm. The softening temperature of the glass was measured to be 940° C. with use of the heating micrometer.

### Example 7

A composite sintered body was produced in the same manner as in Example 6 except that the sintering temperature was 875° C., and the holding time at 875° C. was 4 hours.

### Example 8

A composite sintered body was produced in the same manner as in Example 6 except that the sintering temperature was 900° C., and the holding time at 900° C. was 4 hours.

### Example 9

A composite sintered body was produced in the same manner as in Example 6 except that the weight mixing ratio of a glass powder and a conductive oxide powder was 75:25, and the sintering temperature was 850° C., and the holding time at 850° C. was 4 hours.

### Example 10

A composite sintered body was produced in the same manner as in Example 6 except that the following conductive oxide was used.

SnO₂ powder and Sb₂O₃ powder having the average particle diameter of not more than 1 μm were mixed at a weight ratio of 100:2, and heated at 1000° C. in air for 4 hours, thereby obtaining SnO₂ powder in which Sb was solid solved.

### Example 11

A composite sintered body was produced in the same manner as in Example 11 except that the mixing weight ratio of the SnO₂ powder and the Sb₂O₃ was 100:17.5.

### Example 12

A composite sintered body was produced in the same manner as in Example 6 except that glass colored by the following method was used.

Into 100 parts by weight of the glass composition in Example 6 was added 0.5 parts by weight of CoO as a colorant, thereby preparing glass colored cerulean. The resulting glass was ground, thereby obtaining glass powder having the average particle diameter of 6.1 μm. The softening point of the glass was 940° C.

### Example 13

A composite sintered body was produced in the same manner as in Example 6 except that glass colored by the following method was used.

Into 100 parts by weight of the glass composition in Example 6 was added 1 parts by weight of MnO₂ as a colorant, thereby preparing glass colored magenta. The resulting glass was ground, thereby obtaining glass powder having the average particle diameter of 6.1 μm. The softening point of the glass was 940° C.

### Example 14

A composite sintered body was produced in the same manner as in Example 6 except that glass colored by the following method was used.

Into 100 parts by weight of the glass composition in Example 6 was added 0.15 parts by weight of Cr₂O₃ as a colorant, thereby preparing glass colored yellow green. The resulting glass was ground, thereby obtaining glass powder having the average particle diameter of 6.1 μtm. The softening point of the glass was 940° C.

TABLE 1

| | Glass- | Amount of | Amount of | | | | | | Coefficient | |
|---|---|---|---|---|---|---|---|---|---|---|
| | softening | entire alkali | lithium oxide | Amount | Amount | | Open | Electric | of thermal | Young's |
| | temperature | glass | in glass | of glass | of oxide | Density | porosity | resistivity | expansion | modulus |
| | (° C.) | (wt %) | (wt %) | (wt %) | (wt %) | (g/cm³) | (%) | (Ω · cm) | (ppm/K) | (GPa) |
| 1 | 920 | 12.7 | 9.9 | 65 | 35 | 3.08 | 0.13 | 1.0 × 10⁶ | 9.0 | — |
| 2 | 920 | 12.7 | 9.9 | 65 | 35 | 3.07 | 0.08 | 4.1 × 10⁵ | 3.6 | — |
| 3 | 800 | 13.5 | 0.0 | 65 | 35 | 3.12 | 0.10 | 2.5 × 10⁴ | 7.6 | — |
| 4 | 810 | 14.4 | 0.0 | 70 | 30 | 3.01 | 0.02 | 3.1 × 10⁵ | 3.6 | — |
| 5 | 970 | 1.5 | 0.0 | 70 | 30 | 3.12 | 0.10 | 4.0 × 10⁴ | 6.0 | — |
| 6 | 940 | 1.5 | 0.0 | 70 | 30 | 3.31 | 0.06 | 5.5 × 10³ | 7.3 | 135 |
| 7 | 940 | 1.5 | 0.0 | 70 | 30 | 3.29 | 0.07 | 2.2 × 10⁴ | 6.8 | 140 |
| 8 | 940 | 1.5 | 0.0 | 70 | 30 | 3.30 | 0.08 | 8.5 × 10⁴ | 6.2 | 160 |

TABLE 2

| | Glass- | Amount of | Amount of | | | | | | Coefficient | |
|---|---|---|---|---|---|---|---|---|---|---|
| | softening | entire alkali | lithium oxide | Amount | Amount | | Open | Electric | of thermal | Young's |
| | temperature | glass | in glass | of glass | of oxide | Density | porosity | resistivity | expansion | modulus |
| | (° C.) | (wt %) | (wt %) | (wt %) | (wt %) | (g/cm³) | (%) | (Ω · cm) | (ppm/K) | (GPa) |
| 9 | 940 | 1.5 | 0.0 | 75 | 25 | 3.20 | 0.04 | 7.5 × 10⁵ | 7.5 | 130 |
| 10 | 940 | 1.5 | 0.0 | 70 | 30 | 3.30 | 0.07 | 2.1 × 10⁵ | 7.3 | — |
| 11 | 940 | 1.5 | 0.0 | 70 | 30 | 3.32 | 0.05 | 8.8 × 10⁵ | 7.2 | — |
| 12 | 940 | 1.5 | 0.0 | 70 | 30 | 3.31 | 0.08 | 9.5 × 10⁴ | 7.2 | — |
| 13 | 940 | 1.5 | 0.0 | 70 | 30 | 3.32 | 0.05 | 4.8 × 10⁵ | 7.2 | — |
| 14 | 940 | 1.5 | 0.0 | 70 | 30 | 3.31 | 0.09 | 7.7 × 10⁵ | 7.2 | — |

TABLE 3

| | | Alkali-dissolved amount | | | | Hire of | |
|---|---|---|---|---|---|---|---|
| | Strength | (μg/cm²) | | | | sintered | |
| | (MPa) | total | Li | Na | K | body | Crystalline phase |
| 1 | 230 | 4.9 | 4.2 | 0.2 | 0.5 | thin blue | SnO₂, Li₂Si₂O₅ |
| 2 | 165 | 4.6 | 3.9 | 0.2 | 0.5 | thin blue | SnO₂, Li₂Si₂O₅ |
| | | | | | | | other unidentified phase |
| 3 | 156 | 1.4 | 0.0 | 1.3 | 0.1 | thin blue | SnO₂ |
| 4 | 147 | 1.5 | 0.0 | 1.4 | 0.1 | thin blue | SnO₂ |
| 5 | 150 | 0.1 | 0.0 | 0.1 | 0.0 | thin blue | SnO₂ |
| 6 | 149 | 1.4 | 0.0 | 1.4 | 0.0 | thin blue | SnO₂ |
| 7 | 155 | 1.2 | 0.0 | 1.2 | 0.0 | thin blue | SnO₂, CaSiO₃ |
| 8 | 170 | 1.1 | 0.0 | 1.1 | 0.0 | thin blue | SnO₂, CaSiO₃ |
| | | | | | | | CaAl₂Si₂O₈ |

TABLE 4

| | | Alkali-dissolved amount | | | | | |
|---|---|---|---|---|---|---|---|
| | Strength | (μg/cm²) | | | | Hire of sintered | Crystalline |
| | (MPa) | total | Li | Na | K | body | phase |
| 9 | 145 | 1.6 | 0.0 | 1.6 | 0.0 | thin blue | SnO₂ |
| 10 | 140 | — | — | — | — | thin blue | SnO₂ |
| 11 | 150 | — | — | — | — | thin blue | SnO₂ |
| 12 | 145 | — | — | — | — | thin purple | SnO₂ |
| 13 | 140 | — | — | — | — | thin reddish purple | SnO₂ |
| 14 | 148 | — | — | — | — | grayish green | SnO₂ |

### Example 15

Application for Spacer Ring

The same glass powder and conductive oxide powder as in Example 6 were used. As a medium, pure water was used, and polyvinyl alcohol was used as a binder. A slurry was prepared by adding and wet mixing a plasticizer into pure water and polyvinyl alcohol. A granulated powder having the average particle diameter of 80 μm was produced from this slurry with use of a spray drier. A ring-shaped molded body was obtained by press molding the granulated powder with a mold. A sintered body was obtained by heating the molded body at 865° C. in air for 4 hours. The molded body was heated at a heating rate of 100° C. from room temperature to 500° C., held at 500° C. for 2 hours, then heated at 300° C./hour up to 865° C., held at 865° C. for 4 hours, and cooled to 500° C. at 300° C./hour.

Opposite surfaces of the ring-shaped sintered body were polished, inner and outer edge surfaces were worked and C-chamfered. A ring-shaped test piece having dimensions of 23.6 mm in outer diameter, 20.2 mm in inner diameter and 1.66 mm in thickness. The test piece had pale blue. The following measurement results were obtained with respect to the test piece thus obtained.

(Center-Line Average Surface Roughness)

A center-line average surface roughness of each of upper and lower surfaces of the ring-shaped test piece was measured to be 0.2 μm by the surface roughness meter.

(Density and Open Porosity)

The density and the open porosity were measured to be 3.30 g/cm³ and 0.5%, respectively, according to the Archimedean method with use of water as medium.

(Electric Resistance)

Silver electrodes were formed on the upper and lower surfaces of the ring-shaped test piece, and electric resistance between the two terminals on the upper and lower surfaces were measured, and the electric resistivity was calculated based on the sectional area and the thickness. As a result, the electric resistivity was 2.4×10⁴ Ω·cm.

(Coefficient of Thermal Expansion)

A rod-shaped test piece test piece having a length of 10 mm was cut out from a ring-shaped test piece, and its coefficient of thermal expansion was measured to be 7 ppm/K with use of a push rod type thermal expansion meter.

(Young's Modulus and Strength)

The ring-shaped test piece was subjected to a radial crushing strength test. As a result, Young's modulus was 140 GPa, and the radial crushing strength was 160 MPa.

(Alkali Dissolving Amount)

A ring-shaped test piece was placed in a Teflon container with 50 ml pure water, and the container was sealed and held at 80° C. for 24 hours. Amounts of lithium, potassium and sodium dissolved into the pure water were measured by atomic-absorption spectroscopy. The dissolved amounts of lithium, potassium and sodium per unit surface area of the composite sintered body were 0.0 μg/cm², 0.0 μg/cm² and 1.6 μg/cm², respectively.

(Measurement of Particles)

Into a Pyrex beaker was poured 500 ml pure water of which number of particles was measured, a ring-shaped test piece was hanged in the pure water with a nylon thread. Next, the beaker was placed in an ultrasonic wave washer where ultrasonic waves were applied to the beaker at room temperature, 38 kHz and 400 W for 10 minutes. Then, the number of particles existing in the water and being 2 μm or more was measured with a particle counter (Lion Co., Ltd.), and the number of particles generated was obtained by subtracting the number of the particles originally existing in the pure water from the measured one. As a result, the number of particles generated per unit surface area of the ring-shaped test piece was 70/cm².

### Example 16

Tests were effected in the same manner as in Example 15, provided that the glass was colored cerulean by adding 0.5 parts by weight of CoO to 100 parts by weight of the glass composition used in Example 15.

As a result, the ring-shaped test piece was colored violaceous. The density and the open porosity of the resulting test piece were 3.30 g/cm³ and 0.5%, respectively. The electric resistivity was 8.9×10⁴ Ω·cm, and the coefficient of thermal expansion 7 ppm/K, Young's modulus 145 GPa, radial crushing strength 165 MPa, and dissolved amounts of lithium, potassium and sodium per unit surface area were 0.0 μg/cm², 0.0 μg/cm², and 1.5 μg/cm², respectively. The number of particles generated was 85/cm² per unit surface area of the ring-shaped test piece.

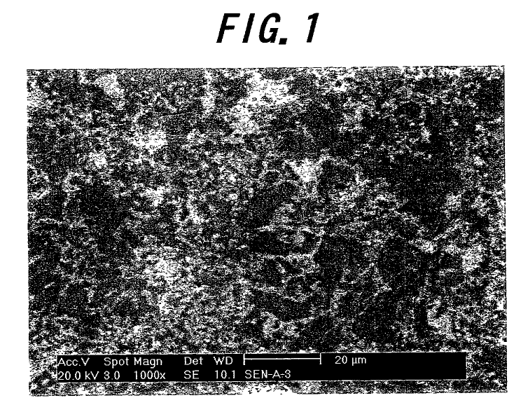

FIG. 1 shows an electron microscopic photograph of a polished surface of the composite sintered body produced in Example 6. In FIG. 1, a tissue observed black is the glass phase, and a whitish tissue is SnO₂ (conductive oxide phase). As is seen in FIG. 1, the composite sintered body has almost no pores, and is fully densified. The conductive oxide phase is dispersed in the glass phase, and extends continuously.

As mentioned above, according to the present invention, the glass-substituting material having high conductivity can be provided.

What is claimed is:

1. A composite sintered body produced from a glass powder and a powder of a conductive oxide, said sintered body having a glass phase and a conductive oxide phase dispersed in said glass phase, wherein said conductive oxide phase extends continuously three-dimensionally, and the composite sintered body has a volume resistance value of not more than 100 MΩ·cm.

2. The composite sintered body set forth in claim 1, wherein at least a part of the glass phase is crystallized.

3. The composite sintered body set forth in claim 1 or 2, wherein the conductive oxide phase is contained at not less than 10 wt % of the composite sintered body.

4. The composite sintered body set forth in claim 1 or 2, which has an open porosity of not more than 0.5%.

5. The composite sintered body set forth in claim 1 or 2, which has a coefficient of thermal expansion of not less than 3 ppm/K and not more than 10 ppm/K.

6. The composite sintered body set forth in claim 1 or 2, which has a Young's modulus of not less than 100 GPa.

7. The composite sintered body set forth in claim 1 or 2, wherein said conductive oxide phase has a main phase composed of at least one metal oxide selected from the group consisting of SnO₂, In₂O₃, MnO₂, Fe₃O₄, ZnFe₂O₄ and BaTiO₃.

8. The composite sintered body set forth in claim 7, wherein said conductive oxide phase contains an oxide of other metal element that has a valency greater than that of metal elements constituting said at least one metal oxides and is solid solved in said at least one metal oxide.

9. The composite sintered body set forth in any one of claims 1 to 6, wherein said conductive oxide phase has a main phase composed of at least one metal oxide selected from the group consisting of NiO and CoO.

10. The composite sintered body set forth in claim 9, wherein said conductive oxide phase contains an oxide of other metal element that has a valency smaller than that of metal elements constituting said at least one metal oxides and is solid solved in said at least one metal oxide.

11. The composite sintered body set forth in claim 8 or 10, wherein the amount of said oxide of said other metal element is not less than 0.1 parts by weight and not more than 20 parts by weight when the amount of metal oxide constituting the main phase is taken as 100 parts by weight.

12. The composite sintered body set forth in claim 11, wherein the main phase of the conductive oxide phase is SnO₂, and said oxide of said other metal element is at least one metal oxide selected from the group consisting of Sb₂O₃, Sb₂O₅, Ta₂O₅ and Nb₂O₅.

13. The composite sintered body set forth in any one of claims 1 to 12, wherein an amount of an oxide of an alkali metal element in said glass phase is not more than 15 wt %.

14. The composite sintered body set forth in any one of claims 1 to 13, wherein an amount of lithium oxide in said glass phase is not more than 1 wt %.

15. The composite sintered body set forth in any one of claims 1 to 14, wherein a transition metal is incorporated into the glass phase in such a fine amount as to color said composite sintered body.

16. The composite sintered body set forth in any one of claims 1 to 15, wherein a total dissolved amount per a unit surface area of said composite sintered body of an alkali metal element into 50 ml pure water when the composite sintered body is immersed in the pure water at 80° C. for 24 hours is not more than 5.0 am.

17. A conductive part for an electronic device, said conductive part comprising the composite sintered body set forth in any one of claims 1 to 16.

18. The conductive part set forth in claim 17, which is an earth part.

19. The conductive part set forth in claim 17 or 18, which is a spacer for a hard disc.

20. The conductive part set forth in claim 17, which is a disc for a magnetically recording medium.

21. The conductive part set forth in any one of claims 17 to 20, which has a center-line average surface roughness of not more than 0.5 μm.

22. The conductive part set forth in any one of claims 17 to 20, wherein the number of particles per a unit surface area the composite sintered body of not less than 2 μm generated in a ultrasonic wave-applying test in pure water is not more than 100/cm².

23. A process for producing a composite sintered body, comprising the steps of preparing a molded body by molding a mixed powder of a glass powder and a powder of a conductive oxide, sintering the glass powder by heating the molded body, and thereby forming a glass phase and a conductive oxide phase dispersed in said glass phase.

24. The producing process set forth in claim 23, wherein a temperature on sintering is lower than a softening temperature of the glass.

25. The producing process set forth in claim 23 or 24, wherein said conductive oxide powder is prepared by mixing a powder of a first metal oxide constituting a main phase of said conductive oxide phase with an oxide powder of a second metal element having a valency different from that of a metal element constituting the first metal oxide.
